(19) United States
(12) Patent Application Publication
(10) Pub. No.: US 2003/0042630 A1
(43) Pub. Date: Mar. 6, 2003

(54) Bubbler for gas delivery

(76) Inventors: Jason E. Babcoke, Menlo Park, CA (US); Tony P. Chiang, Santa Clara, CA (US); Karl F. Leeser, San Jose, CA (US)

Correspondence Address: SKJERVEN MORRILL LLP, 25 METRO DRIVE, SUITE 700, SAN JOSE, CA, 95110, US

(21) Appl. No.: 09/947,418

(22) Filed: Sep. 5, 2001

(51) Int. Cl. B01F 3/04

(52) U.S. Cl. 261/121.1; 96/360

(57) ABSTRACT

A bubbler for gaseous delivery comprises a receptacle for containing a liquid, a gas inlet conduit, and a gas outlet conduit. The gas inlet conduit includes a first end for receiving a carrier gas and a second end terminating in the receptacle for bubbling the carrier gas into the liquid. The gas outlet conduit includes a first portion, a second portion, and a third portion. The first portion includes an opening located within the receptacle but above the liquid. The opening has a first cross-sectional area. The second portion has a second cross-sectional area larger than the first cross-sectional area. The third portion has a third cross-sectional area smaller than the second cross sectional area. The second portion causes a burp of the liquid entering the opening to not enter the third portion as gas is bubbled through the liquid.

### FIELD OF THE INVENTION

The present invention relates generally to an apparatus for gas delivery and more particularly to a bubbler for gaseous delivery of a precursor.

### BACKGROUND OF THE INVENTION

A bubbler is designed to deliver a gaseous form of a precursor through the use of a carrier gas. The bubbler contains the precursor in liquid form and may contain some of the precursor in gaseous form inside the bubbler. At a specific temperature and pressure, some of the liquid will change to the gas phase due to vapor pressure. The rate at which the liquid changes to the gas phase can be increased by raising the temperature or lowering the pressure inside the bubbler. In addition, the rate at which the liquid changes to the gas phase can also be increased by the use of a carrier gas. Carrier gas is supplied to the bubbler through an inlet tube that protrudes through the liquid surface. In steady state conditions, the carrier gas flowing through the tube is mixed with, or “bubbled” through, the liquid. The bubbling effectively increases the surface area of the liquid exposed to the carrier gas. Exposing more surface area of the liquid to the carrier gas increases the rate at which the liquid transitions into the gas phase and, thus, increases the amount of the gaseous form of the liquid precursor. The combined gaseous precursor and carrier gas then exit through an exit tube, and the gaseous precursor and carrier gas are delivered to a processing chamber.

When the bubbler is started after a period of non-use, there may be liquid precursor in the inlet tube, since the end of the tube is below the surface of the precursor. The precursor in the inlet tube forms a hydraulic head. The hydraulic head must be displaced by the carrier gas so that the carrier gas can be bubbled through the liquid. This displacement requires an increase in pressure. The increase in pressure can impart enough kinetic energy for an upward splash of the precursor to enter the exit tube. This liquid in the exit tube blocks the passage of gas in the exit tube and is forced through the tube by the gas pressure. The liquid then undesirably passes into subsequent gas lines, valves, or a process chamber following the exit tube and may contaminate such subsequent equipment.

In addition, the amount of liquid precursor in subsequent gas lines would likely be unknown, so the amount of precursor, liquid and gas, delivered to a subsequent processing step would also likely be unknown. Thus, subsequent processing steps may be uncontrollable.

### SUMMARY

A bubbler for gaseous delivery comprises a receptacle for containing a liquid, a gas inlet conduit, and a gas outlet conduit. The gas inlet conduit includes a first end for receiving a carrier gas and a second end terminating in the receptacle for bubbling the carrier gas into the liquid. The gas outlet conduit includes a first portion, a second portion, and a third portion. The first portion includes an opening located within the receptacle but above the liquid. The opening has a first cross-sectional area. The second portion has a second cross-sectional area larger than the first cross-sectional area. The third portion has a third cross-sectional area smaller than the second cross sectional area. The second portion causes a burp of the liquid entering the opening to not enter the third portion as gas is bubbled through the liquid. Such liquid may eventually drip back into the receptacle when the bubbler is not active.

The gas inlet conduit may be a tube. In one embodiment, the gas inlet conduit may include a check valve. The gas outlet conduit may also be a tube. In one embodiment, the gas from the gas outlet conduit may be received by a process chamber.

The bubbler may include a baffle plate. The baffle plate may be located within the receptacle or within the second portion of the gas outlet conduit.

### BRIEF DESCRIPTION OF THE DRAWINGS

For a more complete understanding of the present invention and for further features and advantages, reference is now made to the following description, taken in conjunction with the accompanying drawings, in which:

FIG. 1 is a schematic diagram of a process flow involving a bubbler, according to an embodiment of the present invention;

FIG. 2 is a schematic diagram of a bubbler, according to an embodiment of the present invention;

FIG. 3 is a schematic diagram of a bubbler, according to another embodiment of the present invention;

FIG. 4 is a schematic diagram of a bubbler, according to another embodiment of the present invention; and

FIG. 5 is a schematic diagram of a bubbler, according to another embodiment of the present invention.

In the drawings, like numerals are used for like and corresponding parts.

### DETAILED DESCRIPTION

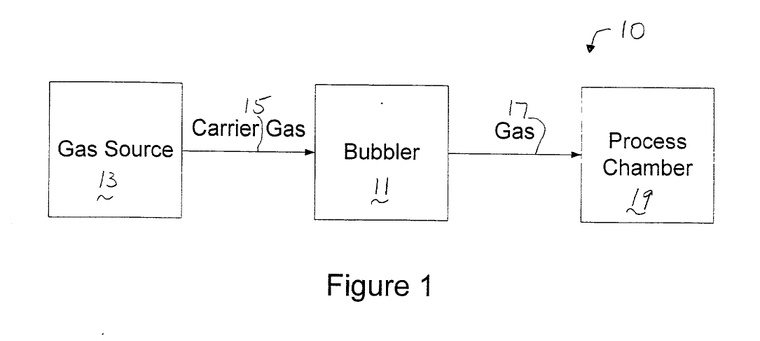

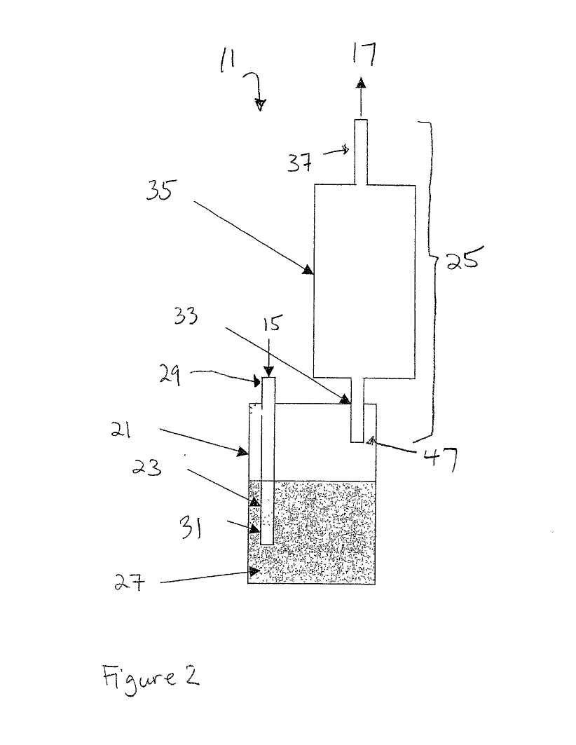

FIG. 1 is a schematic diagram of a process flow 10 involving a bubbler 11, according to an embodiment of the present invention. A gas source 13 provides a carrier gas 15 to the bubbler 11. The gas source 13 may be a gas cylinder. The carrier gas 15 is typically argon, helium, nitrogen, or any other inert gas. The bubbler 11 may contain a liquid precursor 27 (described below), as shown in FIG. 2.

Gas 17 exits the bubbler 11 and enters a process chamber 19. The gas 17 may include the carrier gas 15 and a gaseous form of the liquid precursor 27. The process chamber 19 may be used in any type of chemical processing, such as chemical vapor deposition or atomic layer deposition.

FIG. 2 is a schematic diagram of a bubbler 11, according to an embodiment of the present invention. The bubbler 11 includes a receptacle 21, a gas inlet conduit 23, and a gas outlet conduit 25. The receptacle 21 may be any container or ampoule used to contain or hold a liquid. Receptacles 21 are commercially available and known in the art. In one embodiment, the receptacle 21 may be a 1.2 liter stainless steel source container, part number BK1200SSN, or a standard breakseal bubbler, part number BK3D1, both available from Schumacher, Carlsbad, Calif. 92009.

The receptacle 21 contains a liquid precursor 27. The liquid precursor 27 may be any element, compound, matter, substance, or chemical in liquid form. In one embodiment, the liquid precursor may be an organometallic precursor, such as pentakis(diethylamido)tantalum (PDEAT), pentakis(ethylmethylamido)tantalum (PEMAT), t-butylimino tris(diethylamino) tantalum (TBTDET), tetrakis (dimethylamido)titanium (TDMAT), tetrakis(diethylamido)titanium (TDEAT), and (trimethylvinylsilyl)hexafluoroacetylacetonato copper I (Cu(TMVS)(hfac) or Cupraselect®).

The bubbler 11 increases the rate at which the liquid precursor 27 changes from a liquid phase to a gas phase by raising the temperature or lowering the pressure inside the receptacle 21. Carrier gas 15 enters the receptacle 21 through the gas inlet conduit 23 and exits the receptacle 21 through the gas outlet conduit 25. As the carrier gas 15 flows through the receptacle 21, it is bubbled through the liquid precursor 27. The bubbling increases the surface area of the liquid precursor 27 exposed to the carrier gas 15. Thus, the rate of transition from the liquid to gas phase is increased, and the amount of the precursor 27 in the gas phase is increased. The carrier gas 15 also provides a means for transporting the gaseous form of the liquid precursor 27 through the gas outlet conduit 25. In one embodiment, the bubbler 11 may be operated at about 70° C. and about 8 torr.

Upon startup of the bubbler 11, displacement of a hydraulic head of liquid precursor 27 in the gas inlet conduit 23 by the carrier gas 15 may ultimately cause the liquid precursor 27 to splash up and enter the gas outlet conduit 25, as previously described. In certain manufacturing processes, the problem of liquid precursor 27 in the gas outlet conduit 25 is more prevalent. For example, batch processing requires starting and shutting down the bubbler 11 for each batch. Each time the bubbler 11 is started up, the problem of the liquid precursor 27 in the gas outlet conduit 25 may be encountered. Another example is a process flow in which the gas 17 is cycled to a process chamber 19. Gas 17 may be flowed for a period of time to the process chamber 19, be turned off and then turned on again, as part of the processing occurring in the process chamber 19. Each time the carrier gas 15 is turned off, a hydraulic head of liquid precursor 27 may form in the gas inlet conduit 23. Each time the carrier gas 15 is turned on, liquid precursor 27 may enter the gas outlet conduit 25.

The gas inlet conduit 23 includes a first end 29 and a second end 31. The gas inlet conduit 23 may be a tube. The first end 29 is typically outside the receptacle 21, and the second end 31 terminates in the receptacle 21. Carrier gas 15 from a gas source 13 enters the gas inlet conduit 23 through the first end 29 and exits through the second end 31. The second end 31 preferably terminates in the liquid precursor 27 so that carrier gas may be bubbled into the liquid precursor 27.

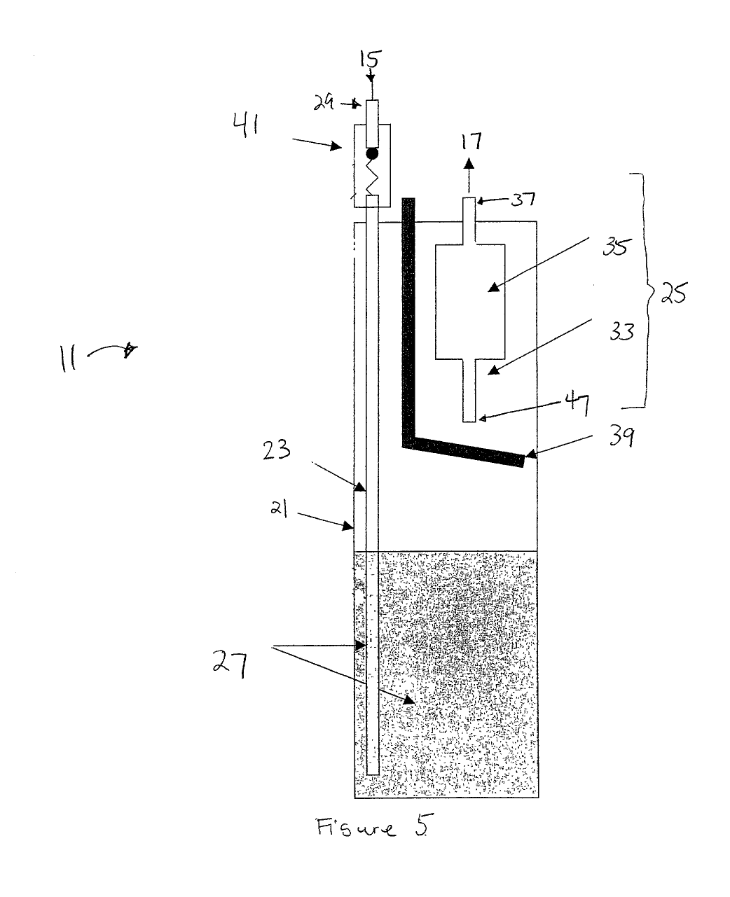

The gas inlet conduit 23 may include a check valve 41, as shown in FIG. 5, to prevent the liquid precursor 27 from entering the gas inlet conduit 21. The check valve 41 allows the carrier gas 15 to flow in only one direction, thus eliminating any liquid precursor 27 from “back flowing” (i.e., liquid precursor 27 flowing up the gas inlet conduit 23) during operation. This check valve can be used on any portion of the gas inlet conduit 23, top or bottom.

The gas outlet conduit 25 includes a first portion 33, a second portion 35, and a third portion 37. The gas outlet conduit 25 may be a tube. Gas 17 enters the first portion 33, flows through the second portion 35, and exits through the third portion 37. The gas 17 may include the carrier gas 15 and a gaseous form of the liquid precursor 27. After exiting the gas outlet conduit 25 of the bubbler 11, the gas 17 may flow to a process chamber 19.

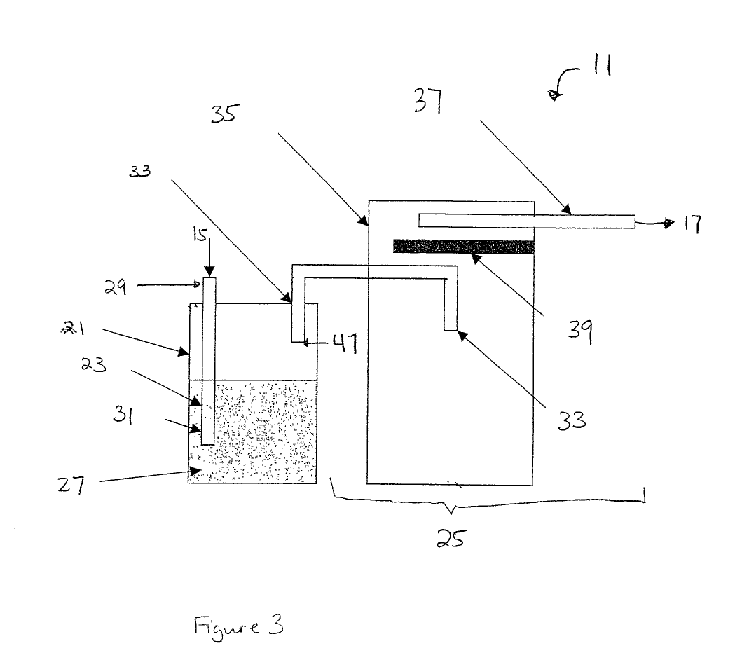

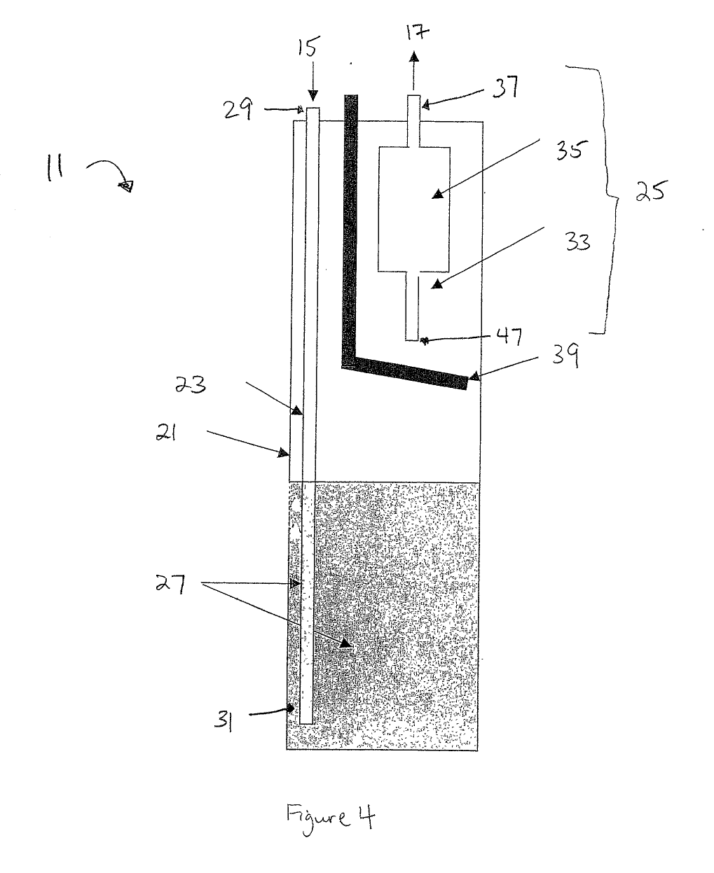

The first portion 33 of the gas outlet conduit 25 may be entirely within the receptacle 21, as shown in FIGS. 4 and 5, or may be partially inside the receptacle 21 and partially outside the receptacle 21, as shown in FIGS. 2 and 3. The first portion 33 includes an opening 47 located within the receptacle 21. The opening 47 is usually above the liquid precursor 27. In steady state conditions, gas 17 enters the opening 47. During the startup of the bubbler 11, the liquid precursor 27 may enter the opening 47, as previously described.

The second portion 35 may be outside (as shown in FIGS. 2 and 3), inside (as shown in FIGS. 4 and 5), or partially inside and partially outside the receptacle 21. The second portion 35 prevents any liquid precursor 27 that does enter the first portion 33 from exiting through the third portion 37. The second portion 35 causes a burp of the liquid precursor 27 entering the opening 47 to not enter the third portion 37 as the carrier gas 15 is bubbled through the liquid precursor 27. The size of the second portion 35 is designed such that any liquid ejected from the receptacle 21 during the initialization of carrier gas 15 flow will be at least temporarily contained within the second portion 35. The second portion 35 can be sized by cross-sectional area, height, or volume.

In the first embodiment, the first portion 33 has a first cross-sectional area; the second portion 35 has a second cross-sectional area; and the third portion 37 has a third cross sectional area. The second cross-sectional area is larger than the first cross-sectional area and larger than the third cross-sectional area. The liquid precursor 27 may be pushed by the gas 17 through the first portion 33. The larger cross-sectional area of the second portion 35 causes any liquid precursor 27 to spread out, allowing gas 17 to pass through the second portion 35, while any liquid precursor 27 returns to the receptacle 21 through gravity, as shown in FIGS. 2, 4, and 5, or remains in the second portion 35, as shown in FIG. 3. In a preferred embodiment, the diameter of the second portion 35 is about two to about 2.5 times larger than the diameter of the first portion 33 and about two to about 2.5 times larger than the diameter of the third portion 37. The bottom of the second portion 35 may be slightly angled to allow the liquid precursor 27 to flow back into the receptacle 21 after the carrier gas 15 is turned off.

In the second embodiment, the height of the second portion 35 is designed such that under the anticipated flow conditions, the gas 17 does not have sufficient kinetic energy to push the liquid precursor 27 to the exit port of the second portion 35. If the height of the second portion 35 were relatively short, then the gas 17 may have sufficient kinetic energy to push the liquid precursor 27 the short distance to the exit port of the second portion 35. If the height of the second portion 35 were relatively long, then the gas 17 may not have sufficient kinetic energy to push the liquid precursor 27 the long distance to the exit port of the second portion 35, and the liquid precursor 27 may flow back into the second portion 35 or the receptacle 21 through gravity. In a preferred embodiment, the height of the second portion 35 is about four inches to about seven inches.

In the third embodiment, the volume of the second section 35 is greater than the volume of the liquid precursor 27 in the receptacle 21. If the volume of the liquid precursor 27 were greater than the volume of the second section 35, then the liquid precursor 27 may fill up the entire second section 35 and overflow into the first section 33 and the third section 37. Since the volume of the second section 35 is greater than the volume of the liquid precursor 27, the liquid precursor 27 is less likely to overflow from the second section 35 to the third section 37.

A baffle plate 39, as shown in FIG. 3, may be used to reduce or prevent any liquid precursor 27 from entering any portion of the gas outlet conduit 25. The complex geometry of a baffle plate 39 helps to divert liquid precursor 27 from any portion of the gas outlet conduit 25. When the liquid precursor 27 contacts the baffle plate 39, the liquid precursor 27 may change direction, may lose kinetic energy, and may return to the receptacle 21. The baffle plate 39 may be in the second portion 35 of the gas outlet conduit 25, as shown in FIG. 3, or in the receptacle 21, as shown in FIGS. 4 and 5.

A right-angled tube may be used to prevent any liquid precursor 27 from entering the third portion 37 of the gas outlet conduit 25. The first portion 33 may be a right-angled tube, as shown in FIG. 3. The right-angled tube directs any liquid precursor 27 towards the bottom of the second portion 35. Thus, the right-angled tube prevents any liquid precursor from entering the third portion 37.

While particular embodiments of the present invention have been shown and described, it will be obvious to those skilled in the art that changes and modifications may be made without departing from this invention in its broader aspects and, therefore, the appending claims are to encompass within their scope all such changes and modifications as fall within the true spirit and scope of this invention.

We claim:

1. A bubbler for gaseous delivery comprising:
a receptacle for containing a liquid;
a gas inlet conduit including a first end for receiving a carrier gas and including a second end terminating in said receptacle for bubbling said gas into said liquid; and
a gas outlet conduit including an opening in a first portion of said gas outlet conduit located within said receptacle but above said liquid, said opening having a first cross-sectional area,
said gas outlet conduit including a second portion with a second cross-sectional area larger than said first cross-sectional area,
said gas outlet conduit including a third portion having a third cross-sectional area smaller than said second cross-sectional area,
said second portion for causing a burp of said liquid entering said opening to not enter said third portion as gas is bubbled through said liquid.

2. The bubbler of claim 1, wherein said gas inlet conduit is a tube.

3. The bubbler of claim 1, wherein said gas inlet conduit further comprises a check valve.

4. The bubbler of claim 1, wherein said gas outlet conduit is a tube.

5. The bubbler of claim 1, wherein the first portion of the gas outlet conduit comprises a right-angled tube.

6. The bubbler of claim 1, further comprising a baffle plate for reducing liquid in said third portion of said gas outlet conduit.

7. The bubbler of claim 6, wherein the baffle plate is located within the receptacle.

8. The bubbler of claim 6, wherein the baffle plate is located within the second portion of the gas outlet conduit.

9. The bubbler of claim 1, wherein the gas from the gas outlet conduit is received by a process chamber.

10. The bubbler of claim 1, further comprising a baffle plate located within the second portion of the gas outlet conduit, and wherein the first portion of the gas outlet conduit comprises a right-angled tube.

11. The bubbler of claim 1, further comprising a baffle plate located within the receptacle, and wherein the gas inlet conduit further comprises a check valve.

12. The bubbler of claim 1, wherein a volume of the second portion of the gas outlet conduit is greater than a volume of the liquid in the receptacle.
